(19) United States
(12) Patent Application Publication
(10) Pub. No.: US 2020/0230653 A1
(43) Pub. Date: Jul. 23, 2020

(54) Screening Material and Screen Assembly

(71) Applicant: Strox Systems, LLC, Houston, TX (US)

(72) Inventor: Jeffrey E. Walker, Lafayette, LA (US)

(21) Appl. No.: 16/652,754

(22) PCT Filed: Sep. 27, 2018
(86) PCT No.: PCT/US2018/053056

§ 371 Date: Apr. 1, 2020

Related U.S. Application Data
(60) Provisional application No. 62/567,017, filed on Oct. 2, 2017.

(51) Int. Cl. B07B 1/46; B01D 33/03

(52) U.S. Cl. CPC B07B 1/4663; E21B 21/065; B01D 33/0376

(57) ABSTRACT

A screen assembly for use in vibratory separators, e.g., shale shakers. The screen assembly has a support with first and second sides, and support surfaces bounded by and connected to at least a portion of the first and second sides. Overlying and adhered to at least portions of the support surfaces is a screen which has alternating planar and undulating portions of screening material.

### CROSS REFERENCE TO RELATED APPLICATION

This application claims priority to U.S. Application No. 62/567,017 filed on Oct. 2, 2017, the disclosure of which is incorporated herein by reference for all purposes.

### FIELD OF THE INVENTION

The present invention relates to screens and screen assemblies used in filtering separators, vibratory separators, and in particular, in shale shakers.

### BACKGROUND OF THE INVENTION

Vibratory separators are used in a wide variety of industrial applications to separate materials such as liquids from solids, or to grade particles. Typically, such separators have a basket found in or over a receiving receptacle and vibrating apparatus for vibrating the basket. One or more screens is generally mounted in the basket. Material to be treated, e.g., drilling mud, is introduced on to the screens. Separated material, e.g., liquid and/or finer solids flow through the screens into a lower receptacle or succeeding screen, and separated larger solids, with or without liquid, move down and off the screen(s).

The use of drilling fluids, commonly referred to as muds, in drilling of oil and gas wells, is well known. Such muds, whether they be aqueous or non-aqueous based, typically contain solids such as clay, various additives, and at certain times, other solids such as fluid loss control additives. During the drilling operation, the drilling mud is pumped down through the drill pipe, through openings in the drill bit, and into the borehole being formed. The mud is then returned to the surface and carries with it solids originally present in the mud, plus cuttings from the wellbore. Upon exiting the wellbore, the drilling mud laden with solids is discharged in various manners over a vibratory separator, known as a shale shaker.

Common shale shakers can have one or multiple screens arranged in tiered or flat dispositions with respect to each other. The prior art is replete with a variety of vibrating screens, devices which use them, shale shakers, and screens for shale shakers. The screens serve the purpose of catching and removing solids from the return mud as the mud passes through them. Failure to remove drilled solids can result in problems with recirculation of the mud since it can create weight, viscosity, and gel problems in the mud. Furthermore, the drilled solids can caused increased wear on the pumps and other mechanical equipment handling the mud in the drilling operations.

Many screens and screen assemblies used in shale shakers are flat or nearly flat, i.e., substantially two dimensional. Other screens, due to corrugated, undulating, depressed, or raised surfaces, are three-dimensional. Such three-dimensional screens are disclosed for example in U.S. Pat. Nos. 5,417,793; 5,417,858; 5,417,859; and 5,598,930, all of which are incorporated herein by reference for all purposes. Three dimensional screens generally comprise an apertured support plate having a plurality of spaced apart apertures or openings therethrough overlaid with a screen having an undulating pattern, i.e., the screening material has a shape which somewhat resembles a sine wave when viewed in side elevation. Thus, the undulations have crests and troughs, the troughs being bonded to the support plate. In general, an undulating screen wherein the crests are about 1″ high offers approximately 40% more screening area than a flat screen.

Certain prior art undulating or corrugated screens can be formed and/or mounted in a shale shaker in such a way that they are slightly convex when viewed in end elevation from the discharge end. Accordingly, when in the shale shaker, the screen forms a generally centrally disposed crown. When the mud to be screened in the shale shaker is introduced onto the screen, because of the slight crown, the material falls off to the sides and pools on opposite sides of the crest of the crown effectively flooding the screen sides. As disclosed in U.S. Pat. Nos. 7,578,394; 8,443,984; 8,910,796; 9,027,760; 9,199,279; 9,370,797; 9,370,798 all of which are incorporated herein by reference for all purposes, this problem can be alleviated to some extent by screen assemblies wherein the screen forms a concave shape when viewed in end elevation, either because the screen is formed in a concave shape or assumes such a shape when placed in a vibratory screening apparatus such as a shale shaker.

One disadvantage of prior art undulating screens is that they are virtually unrepairable once the screening material wears through. Accordingly, the whole screen, including the frame assembly is simply discarded as scrap.

Another disadvantage of prior art undulating screens is that they use a relatively large amount of screening material as compared with a flat screen. In this regard, a conventional prior art undulating screen having dimensions of X by Y has much greater screening area than a flat screen having dimensions of X by Y.

### SUMMARY OF THE INVENTION

In one aspect, the present invention relates to a screen assembly for separation and/or sizing of materials.

In another aspect, the present invention relates to a screen assembly for use in a vibratory apparatus to separate liquids from solids, sizing of solids, etc.

In yet another aspect, the present invention relates to a screen assembly for use in a shale shaker.

In still another aspect, the present invention relates to a screen assembly having undulating portions.

In a further aspect, the present invention relates to an undulating screen assembly for a vibratory apparatus which uses less screening material than such screens/assemblies in the prior art.

In still a further aspect, the present invention relates to an undulating screen assembly which is repairable.

In yet a further aspect, the present invention relates to a screening material.

In one embodiment, the screen assembly of the present invention comprises a support, e.g., a support plate, and one or more layers of screen or screening material overlying and adhered to the support.

In one embodiment, the screen or screening material comprises a generally or substantially planar middle screening portion and first and second spaced undulating/corrugated screening portions on either side of the planar portion. In another embodiment, the screening material comprises an undulating/corrugated screening middle portion, and first and second substantially planar portions on either side of the middle undulating portion.

The present invention discloses, in certain embodiments, a screen assembly for vibrating screen apparatus, e.g. a shale shaker. The screen assembly has one or more layers of screen, screen cloth, and/or mesh. If more than one layer is used, they may be bonded together at discrete points, at discrete areas, or over their entire surface. The layer or layers can be mounted on frame apparatus which may include a solid side support on each of two spaced apart sides of the layer(s), or may include a full four sided screen frame. A strip or strips of support material (e.g. flat steel, aluminum or plastic strips—of any width, but in certain preferred embodiments ranging between a half inch to three inches in width; and of any thickness, but in certain preferred embodiments ranging between one-thirty second and one-eighth inches thick, or rods of these materials with a diameter between one-thirty second and one-eighth inches; any screen may use strips made from different materials, e.g. cross-strips of plastic and end strips of steel, or vice versa) are secured across two or more frame sides. With respect to a two sided frame wherein the two sides are parallel and spaced apart, a strip or strips may be, according to this invention, disposed parallel to the two sides; and, if more than one strip is used, spaced apart across the area of the layer or layers. It is also within the scope of this invention to use a strip or strips which are disposed in a manner non-parallel to the two sides. In one aspect such non-parallel strips may extend diagonally from one end of one side of the frame, across the layer or layers, to a diagonally opposite end of the other side. In another aspect such a strip may extend from any point of a frame side to any point on a non-framed side of the layer or layers. Any such strip (or rod) may be bonded, sintered, welded or otherwise secured (herein refered to collectively as “bonded”) at any point to the layer or layers; at substantially every point of contact between the strip(s) and the layer(s); or at selected intermediate contact points.

In certain embodiments such a strip (or strips) can used with the undulating, three-dimensional portion or layers of screen, screen cloth, screen mesh, or some combination thereof (either non-bonded layers or bonded layers if multiple layers are present). The downwardly projecting areas of the screen, e.g. troughs between valleys, within the scope of this invention, be bonded to the strip(s) or portions thereof, and all or only a portion of a trough may be bonded to the strip(s) or other support surfaces.

With reference to perforated support plates, it will be recognized that whether the perforations are symmetrically formed or are staggered as shown in, for example, FIG. 1 or 7, a “strip” forming a support surface can be formed extending from side to side or end to end as the case may be by the portions of metal bordering the perforations. In other words, the perforations could be of a size and shape, albeit staggered, that the metal separating the perforations could be overlaid by a straightedge from side to side or end to end, as the case may be, and be in contact with a continuous support surface.

In other embodiments in which two frame sides are used, support strips at opposite ends of the frame sides may also serve as end members across the layer(s) ends which do not have frame sides. In one aspect such strips are emplaced at the leading and trailing edges of the layers.

In embodiments of this invention in the undulating portion of the screen and more specifically the troughs which provide a generally lower path for fluid moving on part of or all the way across a screen, the strip or strips according to this invention may be placed beneath the layer or layers at any desired angle to the direction of flow of the fluid across the screen. The screen may be disposed so that fluid flows across the screen either generally in the same direction as the undulations or transverse to such a direction. In either case, a strip or strips beneath the layer(s) may be in the direction of flow or transverse to it.

These and further features and advantages of the present invention will become apparent from the following detailed description, wherein reference is made to the figures in the accompanying drawings.

### BRIEF DESCRIPTION OF THE DRAWINGS

FIG. 1 is a top plan view, showing one type of support plate blank for making a support plate for use in the screen assemblies of the present invention, the blank showing fold lines in phantom.

FIG. 2 is a top plan view of a support plate formed from the plate blank shown in FIG. 1.

FIG. 3 is an end, elevational view of the support plate shown in FIG. 2.

FIG. 4 is an end, elevational view showing a prior art, flat screen assembly including one or more layers of screening material adhered to a support plate and depicting the shape of the support plate when mounted in a shale shaker.

FIG. 5 is an end, elevational view of one embodiment of the screen assembly of the present invention, showing spaced apart portions of undulating screening material secured to a support plate and depicting the shape of the screen assembly when mounted in a shale shaker.

FIG. 6 is a view similar to FIG. 6 showing yet another embodiment of the screen assembly of the present invention.

FIG. 7 is a top plan view of a screen assembly of the present invention showing a portion of the screening material cut away to show a portion of the apertured support plate.

FIG. 8 is an enlarged, cross-sectional view of one of the side mounts and seal assemblies used in the screen assembly of the present invention.

FIG. 9 is an end, elevational view of a portion of a screen assembly according to the present invention wherein the undulations are generally uniform in amplitude, and also shows multiple individual layers of screening material bonded together to form the screen.

FIG. 10 is a view similar to FIG. 9 but showing the undulations having varying amplitude.

FIG. 11 is a prior art schematic sketch showing how drill cuttings pool on opposed sides of the crown of the screen during the screening operation.

FIG. 12 is a view similar to FIG. 11 but shows an embodiment of the screen assembly of the present invention.

FIG. 13 is a view similar to FIG. 12 but showing another embodiment of the screen assembly of the present invention.

FIG. 14 is a view similar to FIG. 12 but showing another embodiment of the screen assembly of the present invention.

FIG. 15 is a view similar to FIG. 14 but showing yet another embodiment of the screen assembly of the present invention.

FIG. 16 is a top plan view of a screening material for use in a screen assembly according to one embodiment of the present invention.

FIG. 17 is a view similar to FIG. 16 but showing another embodiment of the screening material for use in a screen assembly of the present invention.

FIG. 18 is a bottom, plan view of a screen assembly according to one embodiment of the present invention.

FIG. 19 is a bottom, plan view of another embodiment of the screen assembly of the present invention.

FIG. 20 is a view taken along the lines 20-20 of FIG. 18.

FIG. 21 is a cross-sectional view taken along the lines 21-21 of FIG. 19.

### DETAILED DESCRIPTION OF PREFERRED EMBODIMENTS

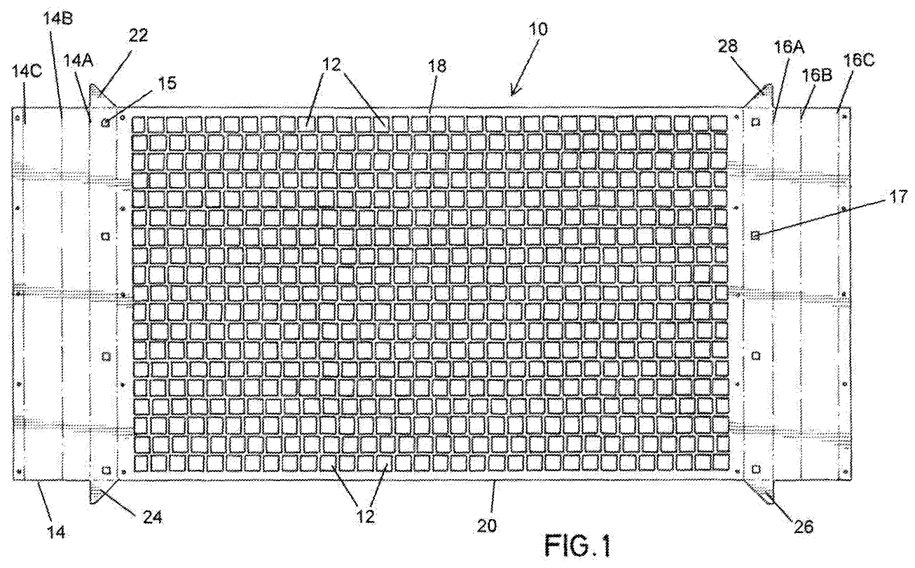

Referring first to FIGS. 1, 2 and 3, the steps used in forming a support or support plate for use in one embodiment of the screen assembly of the present invention are depicted. There is shown a support plate blank 10 which comprises a sheet like structure which can be made of metal, composite or other suitable material. As best seen in FIG. 1, support plate blank 10 has a plurality of generally rectangular apertures 12 which are offset from one another, i.e., staggered, the apertures being generally about 1¼ “by 1”. It will be understood that the perforations can have virtually any shape including circular, although polygonal shapes are preferred. Support plate blank 10 also has a first, laterally extending, side flange portion 14, and a second, laterally extending side flange portion 16, a first end 18, and a second end 20. As depicted in FIG. 1, there are fold lines 14A, 14B, and 14C shown in phantom on flange portion 14, and fold lines 16A, 16B, and 16C shown in phantom on flange portion 16. These lines show where the flange portions 14 and 16 are folded to achieve side mounts, hereafter described. Support plate blank 10 has opposed, laterally extending ears 22 and 24 which project from side flange 14, as well as ears 26 and 28 which project laterally outwardly from side flange 16. As seen, the ears 22-28 are generally triangular. There are a plurality of apertures 15 formed in flange portion 14 and a like plurality of apertures 17 formed in flange portion 16 for purposes hereafter described.

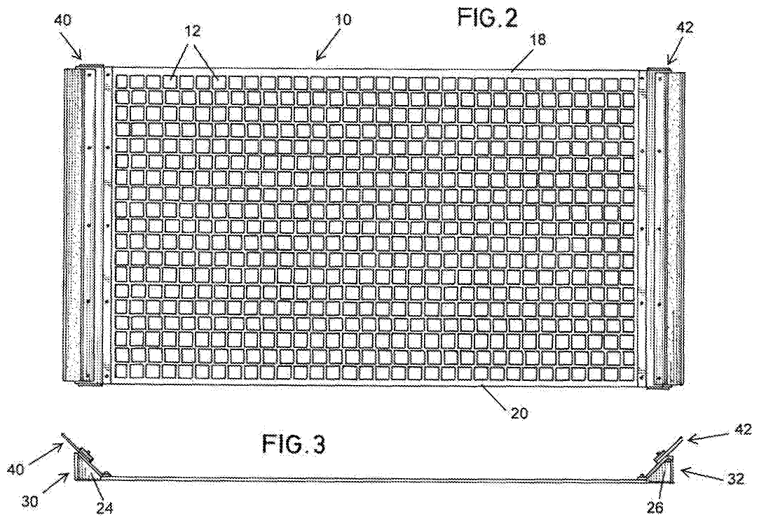

FIGS. 2, 3, and 8 show side mounts 30 and 32 which have been formed by bending or forming support plate blank 10 along fold lines 14A, 14B, and 14C on side flange 14, and bend lines 16A, 16B, and 16C on side flange 16. As best seen in FIG. 3, when flanges 14 and 16 are bent or formed along the fold lines, it results in side mounts 30 and 32, respectively, which are both generally triangular when viewed in end elevation and form triangular channels throughout the length of mounts 30 and 32. FIG. 3 also shows seal assemblies 40 and 42 which are secured to side mounts 30 and 32, respectively.

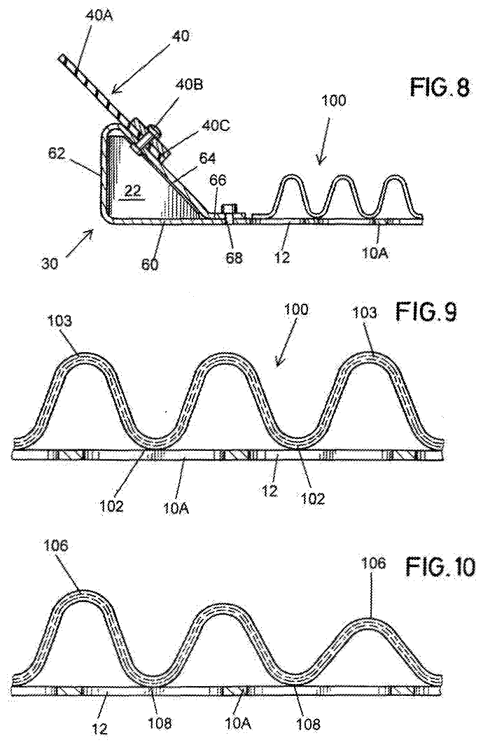

Turning now to FIG. 8, there is shown in enlarged detail, side mount 30, seal assembly 40, a portion of support plate 10A and a portion of a screen 100 described more fully hereafter.

Side mount 30 comprises a first portion or run 60 which is substantially coplanar with support plate 10A, a second portion or run 62 which is generally perpendicular to first run 60, a third portion or run 64 which is at an acute angle to second run 62, and a fourth portion or run 66, which is substantially parallel to first run 60, run 66 being secured to support plate 10A by means of bolts, rivets, or other such fasteners 68. FIG. 8 also shows how ear 22 has been bent or formed so as to overly one end of channel 30A formed in side mount 30, it being understood that ear 24 has similarly been bent so as to overly the opposite end of channel 30A. In this fashion, material being screened is prevented from entering channel 30A and falling through apertures 15 used to secure the screen assembly to the shaker with hooks/fingers 19 as seen in FIG. 5. As also seen in FIG. 8, seal assembly 40 comprises a strip of rubber or other pliable material 40A which is secured by rivet 40B and washer 40C to portion 64 of side mount 30. Thus, FIGS. 2, 3 and 8 show a portion of a completed screen assembly.

In lieu of the side mounts described above, molded side mounts or end caps as described in U.S. Pat. No. 7,866,482, incorporated herein by reference for all purposes can be employed.

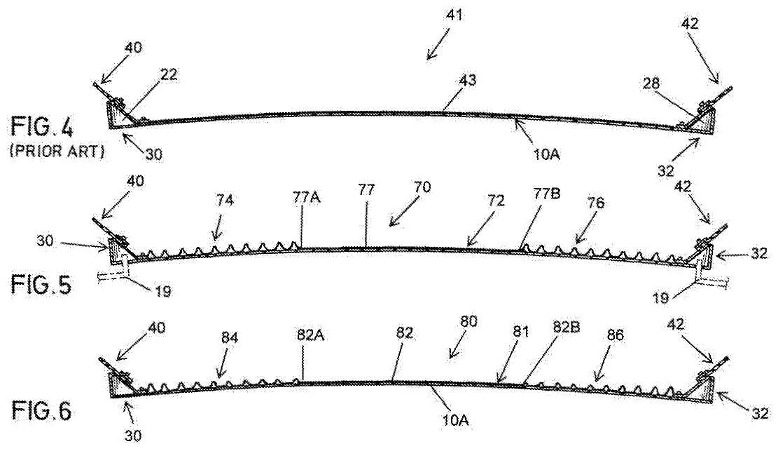

FIG. 4 depicts a prior art flat screen assembly which has a support plate 10A substantially the same as the support plate 10A used in the screen assemblies of the present invention. The prior art screen of FIG. 4 shown generally as 41, as noted above, comprises a support plate 10A including side mounts 30 and 32 and seal assemblies 40 and 42 which also can be used as part of the screen assembly of the present invention. Additionally, prior art flat screen assembly 41 also shows a screen 43, which can be formed of multiple layers of screening material, adhered to support plate 10A. Screen 43 can comprise one or more layers of screening material, the individual layers being of differing mesh size, chosen according to the type of material to be screened. As depicted in FIG. 4, prior art screen 41 is arched which is the configuration it would assume when placed in a typical shale shaker. Thus, screen assembly 41 forms a crown generally midway between side mounts 30 and 32.

Turning now to FIG. 5, there is shown one embodiment of the screen assembly of the present invention. Screen assembly 70 comprises support plate 10A, end mounts 30 and 32, seal assemblies 40 and 42, and a screen shown generally as 72 which overlies and is secured to support plate 10A. Screen 72 comprises a generally centrally located flat screen portion 77 having borders or edges 77A and 77B. Extending from edge 77A toward side mount 30 is a first undulating screen portion 74, while a second undulating screen portion 76 extends from edge 77B toward side mount 32. Again, and as with respect to the prior art embodiment shown in FIG. 4, screen assembly 70 is shown as being convex or arched for the same reasons discussed above with respect to prior art flat screen assembly 41.

Turning to FIG. 6, there is shown still another embodiment of the present embodiment. Screen assembly 80 shown in FIG. 6, like screen assembly 70, comprises a support plate 10A, first and second side mounts 30 and 32, respectively, and seal assemblies 40 and 42 attached to side mounts 30 and 32, respectively. Screen assembly 80 also has a screen 81 overlying and secured to support plate 10A, screen 81 having a generally centrally located flat screen portion 82 and a first side edge 82A and a second side edge 82B. Extending from side edge 82A to side mount 30, is first undulating screen portion 84, while a second undulating screen portion 86 extends from side edge 82B to side mount 32.

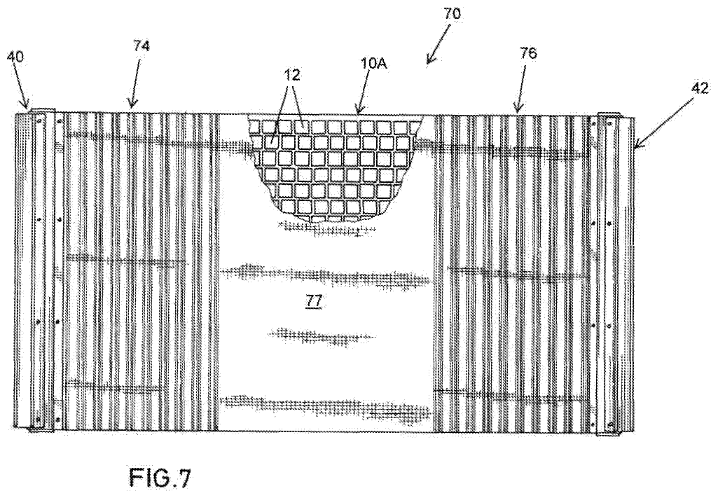

FIG. 7 shows a plan view of the completed screen assembly of FIG. 6 with a portion of the flat screen portion 77 cut away to show apertures 12.

It will be understood that when reference is made to borders or edges 82A and 82B, it is only for purposes of indicating a demarcation between the undulating portions 84, 86 and the flat portion 82. In other words, in both the embodiments of FIGS. 5 and 6, the screens 72 and 81 can be continuous members. However, it is also within the scope of the invention that the undulating portions and the center, flat portions of the screens could be separate sections which are secured to the support plates. In this regard, a pair of parallel strips could be formed abutting support plate 10A, the strips serving as anchor locations for the ends of the undulating portions and the flat portions of the respective screens when those portions are separate.

The embodiment shown in FIG. 6 differs from that shown in FIG. 5 only in the fact that in the case of the undulating portions 74, 76 of the embodiment of FIG. 5, the undulations are generally equal in amplitude. Stated differently, the distances from the roots or troughs to the crests of the undulations are substantially the same for the full length of the undulated portions. However, in the case of the embodiment of FIG. 6, undulating portions 84 and 86 are of decreasing amplitude and in this regard, the undulations have their greatest amplitude adjacent the side mounts, the amplitude generally uniformly decreasing as the undulated portions reach the edges 82A and 82B of the central flat portion 82. It is within the scope of the invention that when the undulations are in decreasing amplitude as shown in FIG. 6, they can effectively run out or vanish into the flat portion 82.

FIG. 9 shows an enlarged, fragmentary view of a portion of a support plate and an undulating screen portion wherein the undulations are of the same amplitude. As seen, the undulating screen portion shown generally as 100 has crests 103 of the same height and valleys or roots 102 which are in contact with and can be adhered to support plate 10A.

FIG. 10 is similar to FIG. 9 with the exception that the screen shown generally as 104 has undulations with a decreasing amplitude, i.e., the crests 100 decrease in height along the length of the undulating portion of the screen 104. As in the case of the embodiment of FIG. 9, the roots 108 can be secured at one or more spots or areas to support plate 10A.

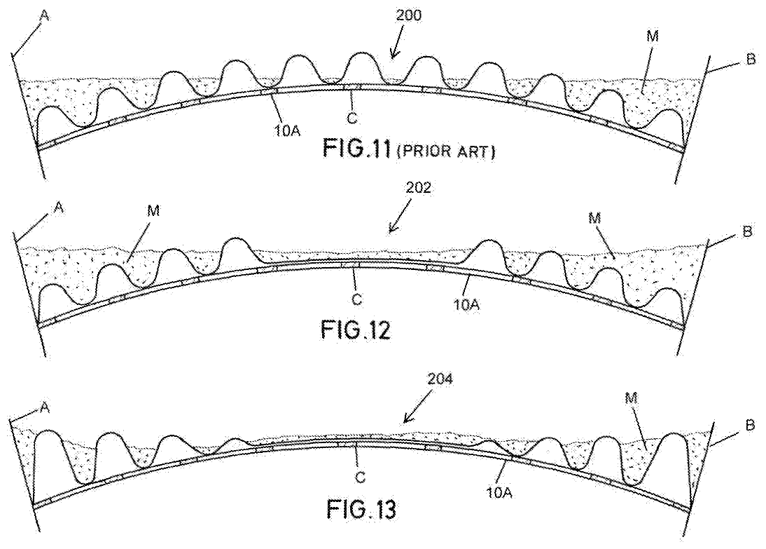

With reference to FIGS. 11-13 the advantages of one embodiment of the screen assembly of the present invention can be readily appreciated. Referring first to FIG. 11, there is shown a prior art undulating screen, which as can be seen has undulations extending completely across the support plate. The screen assembly has a slight arch forming a crown which is approximately ⅞ inch off horizontal. Many typical prior art undulating screens such as shown in FIG. 11 have an amplitude of at least 1 inch, i.e., the height from root to crest. The prior art screen shown generally as 200 is positioned between side walls A and B of the shaker assembly. As can be seen, the drilling mud M containing drill cuttings and other solids pools on either side of the crown C, effectively flooding that area of the screen. Thus there is a much greater volume of mud M adjacent and extending out from walls A and B than there is at the crown C. Significantly, while FIG. 11 shows that the undulations of the screen 200 are flooded or nearly flooded at opposite sides, the undulations of the screen on and adjacent the crown have very little mud coverage. In short, FIG. 11 depicts how on the prior art screen, much of the screening area provided by the portions of the screen overlying and closely adjacent the crown is unused.

In point of fact, it is well known that unless the screen is completely flooded with fluid, the increase in screen area is of no benefit. Clearly in the depiction of FIG. 11, there is not complete flooding of the screen 200—rather only the areas of the screen adjacent the side walls A and B are flooded or nearly flooded. The net result is that unnecessary amounts of screen are used in the prior art systems and it is no value but adds considerable expense to the screen.

With the screen assembly of present invention as shown in the embodiments of either of FIG. 12 or 13, since the center or intermediate portion of the screens 202 and 204 are flat, there is much less screening material required and therefore much less screening material being wasted. By way of example, by making the center portion of the screen 202 substantially flat, there is an approximately 30%-40% decrease in screening area. However, the screen assemblies of the present invention take advantage of the reduced screening area. In this regard, as the mud M is introduced on to the screen, it will move left and right of the crown C and will flood or pool to the left and right of the crown as seen in FIGS. 12 and 13. This allows the center, flat or planar portion of the screens 202 or 204 to more effectively remove drilled solids and allow for greater fluid throughput since that portion of the screens of the present invention are rarely covered with mud.

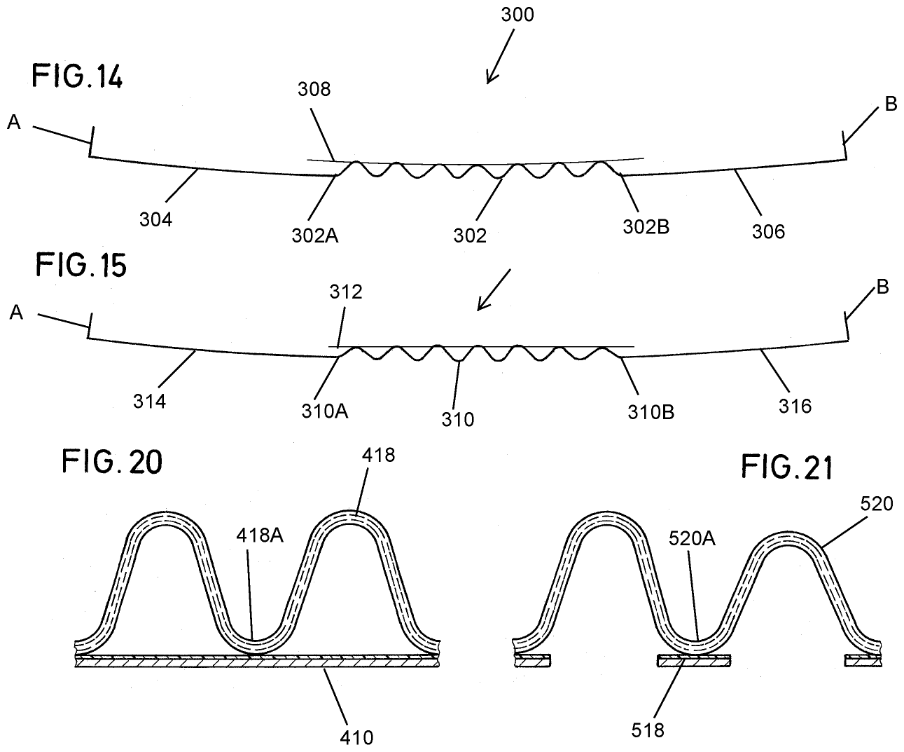

Referring now to FIGS. 14 and 15, there are shown other embodiments of the present invention wherein the undulating portion of the screen is generally intermediate the sides, there are planar areas of screen extending out from each side of the undulating area. If FIGS. 12 and 13 are compared with FIGS. 14 and 15, it can be seen that in general the screening material of the present invention comprises alternating portions of undulating screening material and planar portions of screening material, FIGS. 12 and 13 showing two undulating portions separated by a single planar portion, FIGS. 14 and 15 showing two planar portions separated by a single undulating portion.

With reference first to FIG. 14, the screen assembly, shown generally as 300, comprises a generally centrally disposed undulating portion 302 flanked by first and second planar portions 304 and 306, portions 304 and 306 extending from borders 302A and 302B, respectively, of undulating portion 302. The line 308 in FIG. 14 which runs generally tangentially to the peaks of the undulating portion 302 is a schematic depiction of how solids/mud would be on the screen during a screening operation. Thus, the thickness of the mud would taper off between the undulating portion 302 and wall A on the one hand and the undulating portion 302 and wall B on the other hand. In the embodiment shown in FIG. 14, the undulations of the undulating portion 302 are of equal amplitude. With respect to FIG. 15, the description above with respect to FIG. 14 applies with the exception that the undulating portion 310 of screen 309 has undulations of varying amplitude in the sense that the highest amplitude of the undulating portion 310 is generally midway between the side borders 310A and 310B of the undulating portion 310, the amplitude of the undulations decreasing from the center of the undulating portion 310 toward border 310A and border 310B. In other words, the highest amplitude of the undulating portion 310 would be generally midway between borders 310A and 310B and decreasing generally uniformly from the center of the undulating portion 310 to borders 310A and 310B. As in the case of FIG. 14, the line 312 would generally approximate the thickness of the mud/solids on the screen, the greatest thickness being in the undulating portion 310, the thicknesses of the mud on planar portions 314 and 316 adjacent the sides walls A and B, respectively, being less.

As described above, in relation to FIGS. 12 and 13, when the screen assembly of the present invention is mounted such that in end elevation it has a slightly convex shape, i.e., there is a crown intermediate the sides, a screen assembly wherein alternating portions of undulating screening material flank a generally centrally disposed planar section has advantages. In the case of embodiments depicted in the embodiments of FIGS. 14 and 15, the screen assemblies are formed and/or mounted such that when installed in the vibratory apparatus and when viewed in end elevation, they have a concave shape, it is desirable that the undulating portion of the screen be disposed generally intermediate or midway the opposite sides of the screen, the planar portions of the screen extending from opposite sides of the undulating portion. The advantage of this, concave configuration coupled with the planar portions of the screen being adjacent the side walls of the screening apparatus serves to minimize the buildup of material at those side edges which can result in maintenance and contamination problems.

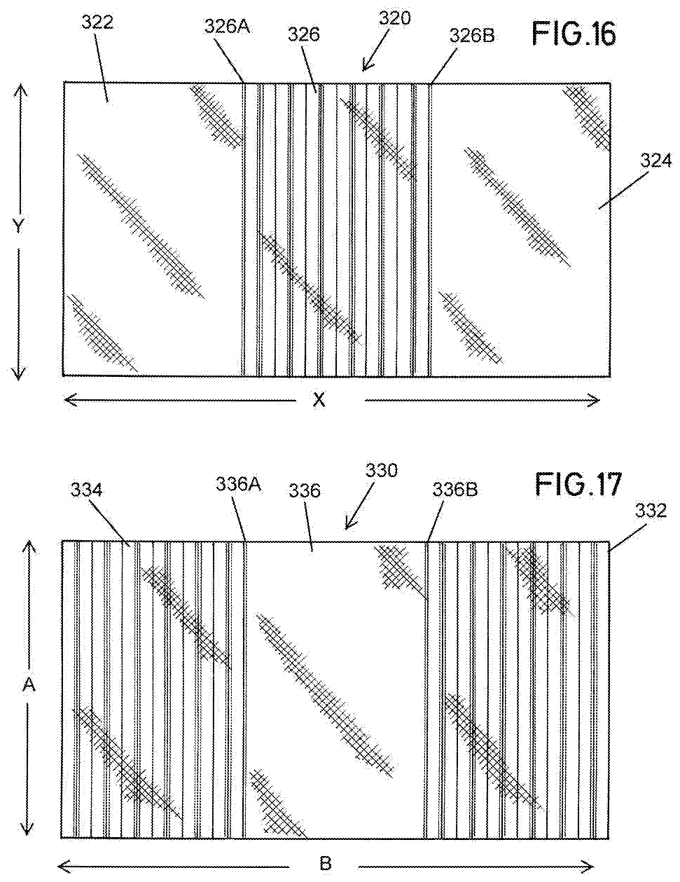

Referring now to FIG. 16, there is shown a screen section 320 having a screening area determined by dimensions X and Y. The screening material being comprised of alternate flat or planar screening sections or portions 322 and 324 which flank a center or intermediate undulating portion 326 having borders 326A and 326B.

FIG. 17 shows screen section 330 having a screening area determined by dimensions A and B which is basically the reverse of the embodiment shown in FIG. 16 in that there are alternating undulating sections or portions 332 and 334 and an intermediate or generally central planar section 336 having borders 336A and 336B. The screening material 320 or 330 could be constructed of one or more layers of wire cloth, screen mesh, or the like, bonded together.

As uses herein the term “screening area” means that portion of the screening material which is or could reasonably be expected to be subject to contact with the material being screened, e.g., drilling mud, or solid mixtures of particles having varying sizes.

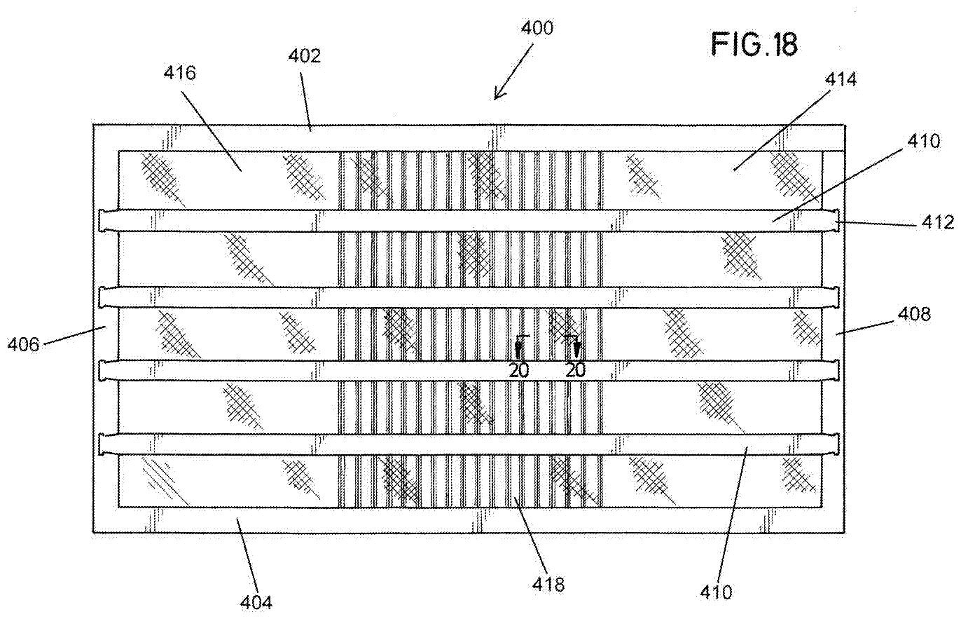

Turning now to FIG. 18 there is shown a screen assembly 400 comprised of side members 402 and 404 and end members 406 and 408 to form a generally rectangular frame. Screen assembly 400 also includes support strips 410 which as seen comprise keyed ends complementary to key notches in end members 406 and 408. The screening assembly 400 also includes planar sections 414 and 416 of screening material and an intermediate undulating portion 418 of screening material.

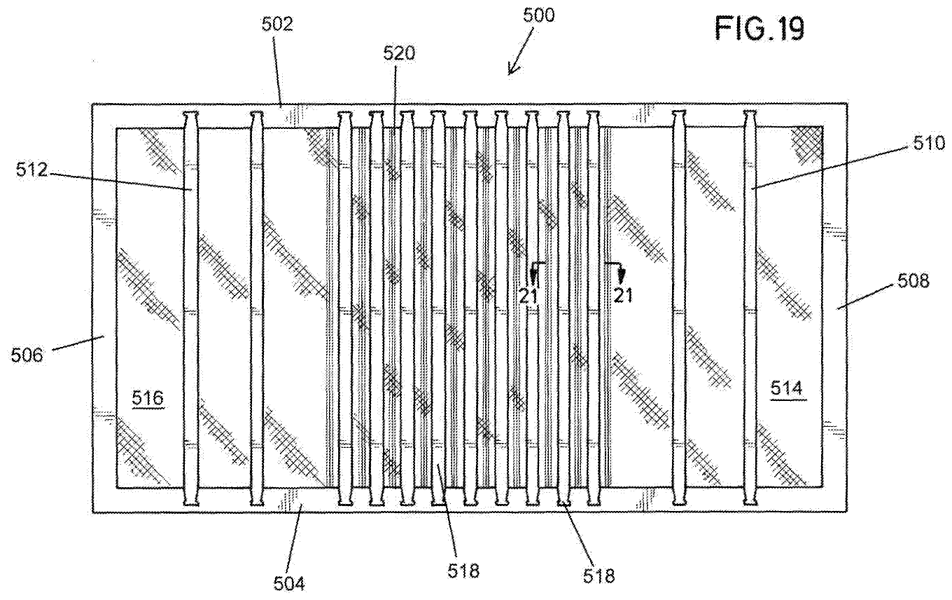

FIG. 19 shows another screen assembly 500 having sides 502 and 504 interconnected to ends 506 and 508 to form a frame, there being strips 510 and 512 underlying planar screening areas 514 and 516, respectively, as well as strips 518 underlying undulating portion 520 of the screening material. As depicted in FIG. 19 and as best shown in FIG. 21, the strips 518 are arranged such that they are attached to and underly the valleys 520A of the undulating screening portion 520. This is to be contrasted with the embodiment shown in FIGS. 18 and 20 wherein the strips 410 are transverse to the troughs 418A of the screening material 418.

In the description above and indeed throughout the application, reference is made to flat or planar portions of the screens. It is to be understood that the flat or planar portions are such prior to the screen assembly being installed in a typical vibratory shaker. Thus, for example with respect to FIG. 12, in the absence of forces acing on screen assembly 202 to force it into the convex shape shown in FIG. 12, the center, planar, screening area between the side undulating portions would be substantially flat or planar, the troughs of the undulations being approximately co-planar with the planar portion of the screening material. Further, in the un-installed condition, the peaks of the undulations of the undulating portions of screen assembly 202 would substantially lie in a single plane substantially parallel to the flat or planar center screening area. With respect to the embodiment of FIG. 13, the above description regarding FIG. 12 is likewise accurate, with the exception that in the case of FIG. 13, the amplitude of the undulations increases from the edge or border of the central, planar screening portion toward the side edges of the screen. Furthermore, as will be understood, if screen 204 in FIG. 13 were not formed into the convex shape such as the case when it is in the vibratory shaker, the crests of the undulating areas of the screen would not, as in the case of screen assembly 202, lie in a single plane parallel to the central, flat screening portion of the screen. A like condition applies to the embodiments of FIGS. 14 and 15.

One advantage of the screens of the present invention which has been alluded to above is that they can be repaired. In this regard, when the flat portions of the screens have worn, thus it can simply be cut and removed from the screen assembly and a new section(s) of flat screen re-applied. Also, when the screen assembly has a perforated support plate, a hole or tear over a perforation can be repaired with a plastic plug cut to be press fit into the perforation. This leads to a significant savings since conventionally, when screens wear, the entire screen including any framing, grid work and the like, is tossed away as scrap metal. Using the designs of the present invention, and since the screen assembly can be repaired multiple times, there is far less waste in that the frame and support plate can be reused.

The screen assemblies of the present invention can include a screen of one or multiple layers of screen, screen cloth, and/or mesh. If more than one layer is employed, they may be bonded together at discrete points, at discrete areas, or over their entire surface.

The screen assembly of the present invention can also include a rigid frame or grid upon which the support plate is mounted which can be made of tubular or solid steel, aluminum, or other similar material. As will be apparent, any suitable plate, grate, strips, frame, etc. which provides support areas to which a screen can be attached may be utilized.

The screen assemblies of the present invention can include a frame with an in-turned edge which facilitates hooking of the screen, e.g., to a vibrating basket.

When the screen comprises multiple layers of screening material, the layers can be adhered to one another using a moisture curing hot melt glue as disclosed in U.S. Pat. No. 6,932,883, incorporated herein by reference for all purposes. Alternatively, the layers of screening material together with the support plate and a frame, if included, can be secured to one another with a powdered epoxy in a semi-cured state, the semi-cured powdered epoxy being heated to thereby bond the various components together. Still other adhesives, plastics, etc. can be used to bond the screen layers together as well as to the support plate and/or frame if the latter is used.

In manufacturing the screen assemblies of the present invention, methods well known to those skilled in the art may be employed. U.S. Pat. No. 5,417,793, incorporated herein by reference for all purposes describes one method which may be used in fabricating at least part of the screen assemblies of the present invention.

In a typical construction of the screens of the present invention and by way of example only, there can be a first, lower layer of a coarse screening material, an intermediate layer of a fine mesh screening material, and an upper layer of yet still a finer screening material.

Whether the screening material is comprised of a single layer of screening material or multiple layers of screening material, the mesh size(s) will be chosen so as to be the most efficacious for the material being screened. Regardless of the particular type of screening material chosen, a screen will generally conform to API RP 13C. Thus, various combinations of screening materials having API screen numbers from API 6-API 635 can be employed. By way of example, a three-layer screen can comprise a coarse screen of about 20 mesh, an intermediate screen of about 180 mesh and a top fine screen of 220 mesh.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. A screen assembly comprising:
a support having a first side, a second side and support surfaces intermediate and connected to at least portions of said first and second sides;
a screen overlying and adhered to at least a portion of said support surfaces, said screen comprising a planar portion and first and second undulating portions, wherein said planar portion is disposed generally intermediate between said first and second sides and has a first and second border, said first undulating portion extending from said first border of said first substantially planar portion toward said first side, and said second undulating portion extends from said second border of said substantially planar portion toward said second side, said undulations of said first and second undulating portions having crests and troughs which are substantially parallel to said first and second borders.

2. The screen assembly of claim 1, wherein said support comprises a first end and a second end, said first and second ends cooperating with said first and second sides to form a frame, said support surfaces being bounded by and connected to at least portions of said frame.

3. The screen assembly of claim 2, wherein said support surfaces comprise a perforate plate.

4. The screen assembly of claim 3, wherein the perforations of said perforate plate are staggered.

5. The screen assembly of claim 2, wherein said support surfaces are formed by a plurality of strips having first and second ends and extending from and connected to said first and second sides of said frame, said first ends being connected to said first sides, and said second ends being connected to said second sides.

6. The screen assembly of claim 2, wherein said support surfaces are formed by a plurality of strips having first and second ends, said first ends of said strips being connected to said first end of said frame, said second ends of said strips being connected to said second end of said frame, said strips being parallel to and underlying the troughs of said undulations.

7. A screen assembly comprising:
a support having a first side A, a second side B and support surfaces intermediate and connected to at least portions of said first and second sides;
a screen overlying and adhered to at least a portion of said support surfaces, said screen comprising an undulating portion and first and second planar portions, wherein said undulating portion is disposed generally intermediate between said first and second sides and has a first border and a second border, said first substantially planar portion extending from said first border of said undulating portion toward said first side, and a second substantially planar portion extending from said second border of said undulating portion toward said second side, said undulations of said undulating portion having crests and troughs which are substantially parallel to said first and second borders.

8. The screen assembly of claim 7, wherein said support comprises a first end and a second end, said first and second ends cooperating with said first and second sides to form a frame, said support surfaces being bounded by and connected to at least portions of said frame.

9. The screen assembly of claim 8, wherein said support surfaces comprise a perforate plate.

10. The screen assembly of claim 9, wherein the perforations of said perforate plate are staggered.

11. The screen assembly of claim 8, wherein said support surfaces are formed by a plurality of strips having first and second ends and extending from and connected to said first and second sides of said frame, said first ends being connected to said first sides, and said second ends being connected to said second sides.

12. The screen assembly of claim 8, wherein said support surfaces are formed by a plurality of strips having first and second ends, said first ends of said strips being connected to said first end of said frame, said second ends of said strips being connected to and underlying said second end of said frame, said strips being parallel to the troughs of said undulations.

13-14. (canceled)

15. A screen comprising:
a screen section having a first side and a second side to form a screening area, said screening area comprising alternating portions of undulating screening material and substantially planar screening material,
wherein when an undulating portion is disposed generally intermediate said first and second sides, said undulating portion forms first and second borders, and there is a first substantially planar portion extending from said first border of said undulating portion toward said first side, and a second substantially planar portion extending from said second border of said undulating portion toward said second side, and
wherein when a planar portion is intermediate said first and said second sides, said planar portion forms first and second borders, and there is a first undulating portion extending from said first border of said substantially planar portion toward said first side, and a second undulating portion extending from said second border of said substantially planar portion toward said second side, said undulations of said undulating portion having crests and troughs which are substantially parallel to said first and second borders.

16. The screen of claim 15, wherein when said undulating portion is intermediate said first and second sides, said undulating portion comprises from about 20 to about 50% of said screening area and said planar portions comprise from about 40 to about 70% of said screening area.

17. The screen of claim 15, wherein when said planar portion is intermediate said first and second sides, said planar portion comprises from about 20 to about 50% of said screening area and said undulating portions comprise from about 40 to about 70% of said screening area.

18. The screen of claim 15, wherein said screening material comprises multiple layers of screening material having different mesh sizes.

19. The screen of claim 18, wherein said layers are bonded to one another.

20. The screen assembly of claim 1, wherein the amplitudes of at least one of said first and second undulating portions varies from one of said first and second borders, respectively, towards one of said first and second sides, respectively.

21. The screen assembly of claim 20, wherein the crests of the undulations of said first undulating portion increase from said first border toward said first side, and the crests of the undulations of said second undulation portion increase from said second border toward said second side.

22. (canceled)

23. The screen assembly of claim 15, wherein the crests of said undulations of said first and second undulating portions vary in amplitude.

24. (canceled)
